(19) United States
(12) Patent Application Publication
(10) Pub. No.: US 2013/0256228 A1
(43) Pub. Date: Oct. 3, 2013

(54) USE OF NOVEL DRAW SOLUTES AND COMBINATIONS THEREOF TO IMPROVE PERFORMANCE OF A FORWARD OSMOSIS SYSTEM AND PROCESS

(71) Applicant: HYDRATION SYSTEMS, LLC, Scottsdale, AZ (US)

(72) Inventors: Upen J. Bharwada, Scottsdale, AZ (US); Isaac V. Farr, Corvallis, OR (US)

(21) Appl. No.: 13/830,933

(22) Filed: Mar. 14, 2013

Related U.S. Application Data
(60) Provisional application No. 61/618,588, filed on Mar. 30, 2012.

(51) Int. Cl. C02F 1/44

(52) U.S. Cl. CPC C02F 1/445
USPC 210/644; 210/201; 252/175; 252/180; 562/400; 562/30; 562/45; 562/89; 568/716; 562/607; 564/281; 564/123; 568/613; 554/227; 554/35; 548/535; 562/104; 562/562; 564/291; 562/567; 562/575

(57) ABSTRACT

This disclosure describes draw solution compositions for FO processes which increase the available membrane area for permeation and are also amenable to reconcentration with standard techniques, such as membrane filtration and evaporative technologies. The composition are comprised of a water soluble draw solute having surface active properties, i.e., a surfactant.

### CROSS REFERENCE TO RELATED APPLICATION

This application claims priority to U.S. provisional application Ser. No. 61/618,588 filed Mar. 30, 2012, the entire disclosure of which is hereby incorporated by reference.

### FIELD OF THE INVENTION

The invention relates to osmotic processes for purifying water and other fluids, in particular forward osmosis processes and systems.

### BACKGROUND OF THE INVENTION

Forward osmosis (FO) membrane devices are made up of two chambers separated by a semipermeable membrane. The membrane allows the passage of water but fundamentally inhibits the transfer of other species. When the chambers are filled with fluids of differing osmotic strength, water is drawn through the membrane from the fluid of lower osmotic strength to the fluid of higher osmotic strength. The fluid of higher osmotic strength is referred to as the “draw solution.” Membranes used for reverse osmosis can be used for FO devices but water flux performance suffers significantly due to a support membrane designed to be operated at high pressures.

A typical state-of-the-art, commercially available reverse osmosis (RO) membrane is designed to withstand pressures of up to 1500 psi. To withstand these high pressures, the leading membrane construction is a two layer thin-film composite (TFC) consisting of a thin polyamide active layer (referred to in the art as the “skin”) on top of a porous, hydrophobic polysulfone support substrate, the substrate having a multitude of tightly packed pores. In FO processes, the porous support substrate faces and is in contact with the draw solution, and the skin faces and is in contact with the feed stream (i.e., the water or other liquid that is to be purified).

### SUMMARY OF THE INVENTION

Disclosed herein are regenerable draw solution formulations for use with forward osmosis (FO) processes and which may be used with RO membranes. Also disclosed are processes and systems using the draw solution formulations. The formulations are surfactant-based, and may consist solely or essentially of a surfactant, or may be comprised of a surfactant combined with one or more of the following: water, an additional surfactant, or a non-surfactant osmolyte. The formulations optionally also comprise a biostatic or biocidal agent. In one embodiment, the draw solution formulation comprises water, an osmolyte that is a surfactant, and a biocidal or biostatic agent. The process of the invention involves purifying a solvent such as water via a FO process, using the draw solution formulation described herein, wherein the resulting spent draw solution may be regenerated.

### DETAILED DESCRIPTION OF THE INVENTION

The draw solution formulations described herein may be used in combination with RO membranes, and increase the accessible area of the membrane, thereby maximizing the overall performance of an FO system. It is believed that the draw solution formulations described herein increase the wetted membrane area, and therefore the usable area for water permeability, leading to an FO flux increase.

The formulation is comprised of a water soluble draw solute having surface active properties, i.e., a surfactant. The surfactant is believed to function by facilitating the increase of available membrane area for permeation.

As used herein, the term “solute” is an osmolyte. The terms “formulation” and “composition” are used interchangeably herein.

In one embodiment, the draw solution formulation or composition consists solely or essentially of a surfactant, preferably a low molecular weight surfactant. The formulation may be regenerated and thereafter re-used.

In another embodiment, the draw solution formulation comprises a surfactant and water.

In still yet another embodiment, the draw solution formulation comprises a surfactant and an another additional water-soluble draw solute, which additional solute may be an additional water-soluble surfactant, a non-surfactant solute, or combination thereof. Optionally, the formulation of this embodiment may also contain water.

Preferably, the formulations further comprise a biocidal agent or a biostatic agent or a combination thereof.

The concentration of the draw solute in the formulation is preferably at least about 5000 ppm. Still more preferably, the concentration is a greater than about 10,000 ppm. The concentration of the draw solute can be as high as the maximum solubility of the given draw solute (or the total solubility of a given combination of two or more draw solutes, if more than one draw solute is used).

The draw solute has surface active properties and is a surfactant. Even more preferably, it is a low molecular weight surfactant. Low molecular weight surfactants have the advantage that they avoid fouling of the membrane. The term “low molecular weight surfactants” as used herein refers to a surfactant having a molecular weight equal to about 500 g/mol or less. Preferably, the surfactant has a molecular weight in the range of about 250 g/mol or less, and even more preferably, of about 125 g/mol.

The surfactant may be non-ionic or ionic. Ionic surfactants may be cationic or anionic.

Certain agents which function as both an osmotic agent and have surfactant properties may be used in draw solution formulations according to the invention. Sodium propionate and polyethylene glycol are examples of compounds that each function as both an osmotic agent and a surfactant. Such formulations would contain water and the osmotic/surfactant agent. Thus, the osmolyte in the draw solution composition according to the invention is a compound which functions as an osmotic agent and has surfactant properties. In yet another embodiment, the osmolyte is comprised of two or more compounds which each function as osmotic agents and have surfactant properties.

Water soluble draw solutes with surface active properties can be selected from a wide range of materials. While not attempting to limit the invention, some materials that fall into this category are as follows:

Anionic solutes, such as carboxylates, sulphonates, petroleum sulphonates, alkylbenzene sulphonates, naphthalene sulphonates, olefin sulphonates, alkyl sulphates, sulphates, sulphated natural oils and fats, sulphated esters, sulphated alkanolamides, alkylphenols, etc.

Specific examples of anionic solutes are trisodium citrate dihydrate, sodium acetate, sodium propionate, sodium lactate, sodium glycolate, sodium glycinate, sodium formate, sodium sulfate, and sodium butyrate.

Cationic solutes, such as quaternary ammonium salts, amines with amide linkages, polyoxyethylene alkyl and alicyclic amines, N,N,N,N-tetrakis substituted ethylene diamines, and 2-alkyl-1-hydroxyethyl-2-imidazolines.

Specific examples of cationic solutes are benzalkonium chloride, benzethonium chloride, Bronidox® (5-bromo-5-nitro-1,3-dioxane), cetrimonium bromide, cetrimonium chloride, dimethyldioctadecylammonium chloride, lauryl methyl gluceth-10 hydroxypropyl dimonium chloride and tetramethylammonium hydroxide, non-ionic (ethoxylated aliphatic alcohol, polyoxyethylene surfactants, carboxylic esters, polyethylene glycol esters, anhydrosorbitol ester and its ethoxylated derivatives, glycol esters of fatty acids, carboxylic amides, monoalkanolamine condensates, polyoxyethylene fatty acid amides, preferably trimethylglycine (betaine), Polyethylene Glycol 600, Polyethylene Glycol 200, Glycerol Sorbitol, Urea Propylene Glycol, ethylene glycol and amino acids such as Proline, Lysine, Serine, Taurine and Glycine).

Specific examples of zwitterionic solutes are N-coco-3-aminopropionic acid/sodium salt, N-tallow 3-imminodipropionatedisodium salt, N-carboxymethyl-N-dimethyl-N-9-octadecenyl ammonium hydroxide, and N-cocoamidethyl-N-hydroxyethylglycine/sodium salt.

In addition to the surfactant or surfactants in the draw solution formulations, the formulations may also contain other solutes. Other examples of draw solutes which may be used include deep eutectic solvents such as metal salts and organic salts (e.g., ZnCl₂ and choline chloride); metal salt hydrates and organic salts (e.g., CoCl₂*6H₂O and choline chloride); organic salts and hydrogen bond donors (e.g., choline chloride and urea); and metal salts (hydrates) and hydrogen bond donors (e.g., ZnCl₂ and urea).

Still yet another type of draw solute which may be used are ionic liquids, such as 1-ethyl-3-methylimidazolium dicyanamide, (C₂H₅)(CH₃)C₃H₃N+2·N(CN)—2, and 1-butyl-3,5-dimethylpyridinium bromide.

And still yet another type of draw solute which may be used are switchable polarity solvents. Examples of switchable polarity solvents are secondary and primary amines that react with CO₂ to form carbamate salts; piperylene sulfone; an equimolar mixture of DBU (1,8-diazabicyclo-[5.4.0]-undec-7-ene) and 1-hexanol; amidine (1,8-diazabicyclo-[5.4.0]-undec-7-ene) (DBU) and a linear alcohol; and other similar materials. (See, “Switchable-polarity solvents (SPS), for example, switch from a lower polarity form to a higher polarity form when a trigger is applied.” ref. J. Org. Chem. 2008, 73, 127-132).

Combinations of one or more draw solutes may optionally be utilized in the formulation. In fact, certain combinations actually provide synergistic effects, where the total osmotic pressure of two different solutes together actually is higher than either solute's osmotic pressure at the same molar concentration. An example of this is the synergistic effect of using a draw solute consisting of glycerol and trehalose combined.

The system of the invention optionally provides a way to re-concentrate or regenerate the draw solution. Optimally, it is re-concentrated or regenerated so that about 95% of the original components of the fresh draw solution are maintained.

The spent draw solution may be re-concentrated or regenerated by processes such as thermal, membrane and aerosol processes, for example, such as by evaporation and membrane filtration. Examples of membrane processes which can be used are forward osmosis (FO), forward osmosis membrane bioreactor (FO-MBR), PRO (pressure retarded osmosis), forward osmosis-reverse osmosis (FO-RO), ultrafiltration forward osmosis (UF-FO), microfiltration forward osmosis (MF-FO), and nanofiltration reverse osmosis (NF-RO). Preferred regeneration processes utilize loose RO (which rejects less species than does typical RO) and NF-RO.

The forward osmosis system comprises a first receptacle for a feed stream of liquid to be treated, a second receptacle for a draw solution composition, a membrane situated between the first and second receptacles, and a further apparatus for regenerating the draw solution composition, wherein the draw solution composition consists essentially of a water-soluble surfactant, and wherein the apparatus for regenerating the draw solution composition is selected from the group consisting of forward osmosis (FO) apparatus, forward osmosis membrane bioreactor (FO-MBR) apparatus, PRO (pressure retarded osmosis) apparatus, forward osmosis-reverse osmosis (FO-RO) apparatus, ultrafiltration forward osmosis (UF-FO) apparatus, microfiltration forward osmosis (MF-FO) apparatus, and nanofiltration reverse osmosis (NF-RO) apparatus.

In a preferred embodiment, the draw solution formulation also contains a biocide or biostat. A number of chemical materials can be used to control growth of microorganisms and are incorporated into the formulation to increase the longevity of the draw solution reconcentration (regeneration) system. Two categories of materials may be useful: biocidal and biostatic. A biocide kills the microorganisms and a biostat inhibits their growth or reproduction. Some chemical materials have both biocidal and biostatic activity.

One or more biocidal or biostatic agents may be used to keep the population level in the lag phase at numbers well below the critical population level. While not attempting to limit the available biocidal agents that can be selected from, the following are thought to be beneficial: natural biocides such as Brassica oleracea, Brassica oleracea gemmifera, and Clostridium botulinum bacteria; pesticides such as fungicides, herbicides, insecticides, algicides, molluscicides, miticides and rodenticides; antimicrobials such as germicides, antibiotics, antibacterials, antivirals, antifungals, antiprotozoals and antiparasitics. While not attempting to limit the available biostatoc agents that can be selected from, the following are thought to be beneficial: bacteriostatic antibiotics, disinfectants, antiseptics and preservatives.

The draw solution composition for forward osmosis processes of the present invention comprises a surfactant as the osmolyte. The draw solution composition may consist essentially of a surfactant. The composition may further comprise one or more of the following: water, an additional water-soluble surfactant, and a non-surfactant osmolyte. The composition may further comprise a biostat or a biocide.

In an exemplary embodiment, the draw solution composition comprises a surfactant as the sole osmolyte. In another embodiment, the composition comprises one more more additional osmolytes, and those additional osmolytes may or may not be surfactants.

In a preferred embodiment, the osmolyte of the draw solution composition is a low molecular weight surfactant. The osmolyte has a molecular weight less than or equal to about 500 g/mol. In yet another embodiment, the osmolyte has a molecular weight less than or equal to about 250 g/mol. In still yet another embodiment, the osmolyte has a molecular weight of about 125 g/mol.

The surfactants useful in the draw solution composition may be non-ionic or ionic. Ionic surfactants may be anionic, cationic or zwitterionic surfactants. Additional osmolytes/solutes in the draw solution composition may be anionic solutes, cationic solutes and zwitterionic solutes and others.

Examples of anionic solutes useful in the composition are those selected from carboxylates, sulphonates, petroleum sulphonates, alkylbenzene sulphonates, naphthalene sulphonates, olefin sulphonates, alkyl sulphates, sulphates, sulphated natural oils and fats, sulphated esters, sulphated alkanolamides, alkylphenols, trisodium citrate dihydrate, sodium acetate, sodium propionate, sodium lactate, sodium glycolate, sodium glycinate, sodium formate, sodium sulfate, and sodium butyrate.

Examples of cationic solutes useful in the composition are those selected from quaternary ammonium salts, amines with amide linkages, polyoxyethylene alkyl and alicyclic amines, N,N,N,N-tetrakis substituted ethylene diamines, and 2-alkyl-1-hydroxyethyl-2-imidazolines, benzalkonium chloride, benzethonium chloride, Bronidox® (5-bromo-5-nitro-1,3-dioxane), cetrimonium bromide, cetrimonium chloride, dimethyldioctadecylammonium chloride, lauryl methyl gluceth-10 hydroxypropyl dimonium chloride and tetramethylammonium hydroxide, non-ionic (ethoxylated aliphatic alcohol, polyoxyethylene surfactants, carboxylic esters, polyethylene glycol esters, anhydrosorbitol ester and its ethoxylated derivatives, glycol esters of fatty acids, carboxylic amides, monoalkanolamine condensates, polyoxyethylene fatty acid amides, preferably trimethylglycine (betaine), Polyethylene Glycol 600, Polyethylene Glycol 200, Glycerol Sorbitol, Urea Propylene Glycol, ethylene glycol and amino acids such as Proline, Lysine, Serine, Taurine and Glycine.

Examples of zwitterionic solutes useful in the composition are selected from N-coco-3-aminopropionic acid/sodium salt, N-tallow 3-imminodipropionatedisodium salt, N-carboxymethyl-N-dimethyl-N-9-octadecenyl ammonium hydroxide, and N-cocoamidethyl-N-hydroxyethylglycine/sodium salt.

The compositions described herein may be used in methods for processing a liquid solvent via forward osmosis, said methods comprising use of a draw solution composition comprising water and an osmolyte, wherein the osmolyte is a surfactant. More specifically, the osmolyte is a low molecular weight surfactant. The draw solution composition constituents are preferably chosen to optimize high FO water flux, low reverse salt rejection, the use of minimal energy to recovery the draw solution and for long-term performance.

1. A draw solution composition for forward osmosis processes consisting essentially of a water-soluble surfactant.

2. The draw solution composition of claim 1, further comprising one or more of the following: water, an additional water-soluble surfactant, and a non-surfactant osmolyte.

3. The draw solution composition of claim 1, further comprising a biostat or a biocide.

4. The draw solution composition of claim 2, further comprising a biostat or a biocide.

5. The draw solution composition of claim 1, wherein the surfactant has a molecular weight less than or equal to about 500 g/mol.

6. The draw solution composition of claim 1 wherein the surfactant has a molecular weight less than or equal to about 250 g/mol.

7. The draw solution composition of claim 1, wherein the surfactant has a molecular weight of about 125 g/mol.

8. The draw solution composition of claim 2, wherein the surfactant has a molecular weight less than or equal to about 500 g/mol.

9. The draw solution composition of claim 2 wherein the surfactant has a molecular weight less than or equal to about 250 g/mol.

10. The draw solution composition of claim 2, wherein the surfactant has a molecular weight of about 125 g/mol.

11. The draw solution composition of claim 1, wherein the surfactant is selected from the group consisting of:
anionic surfactants selected from carboxylates, sulphonates, petroleum sulphonates, alkylbenzene sulphonates, naphthalene sulphonates, olefin sulphonates, alkyl sulphates, sulphates, sulphated natural oils and fats, sulphated esters, sulphated alkanolamides, alkylphenols, trisodium citrate dihydrate, sodium acetate, sodium propionate, sodium lactate, sodium glycolate, sodium glycinate, sodium formate, sodium sulfate, and sodium butyrate;
cationic surfactants selected from quaternary ammonium salts, amines with amide linkages, polyoxyethylene alkyl and alicyclic amines, N,N,N,N-tetrakis substituted ethylene diamines, and 2-alkyl-1-hydroxyethyl-2-imidazolines, benzalkonium chloride, benzethonium chloride, Bronidox® (5-bromo-5-nitro-1,3-dioxane), cetrimonium bromide, cetrimonium chloride, dimethyldioctadecylammonium chloride, lauryl methyl gluceth-10 hydroxypropyl dimonium chloride and tetramethylammonium hydroxide, non-ionic (ethoxylated aliphatic alcohol, polyoxyethylene surfactants, carboxylic esters, polyethylene glycol esters, anhydrosorbitol ester and its ethoxylated derivatives, glycol esters of fatty acids, carboxylic amides, monoalkanolamine condensates, polyoxyethylene fatty acid amides, preferably trimethylglycine (betaine), Polyethylene Glycol 600, Polyethylene Glycol 200, Glycerol Sorbitol, Urea Propylene Glycol, ethylene glycol and amino acids such as Proline, Lysine, Serine, Taurine and Glycine; and
zwitterionic surfactants selected from N-coco-3-aminopropionic acid/sodium salt, N-tallow 3-imminodipropionatedisodium salt, N-carboxymethyl-N-dimethyl-N-9-octadecenyl ammonium hydroxide, and N-cocoamidethyl-N-hydroxyethylglycine/sodium salt.

12. The draw solution composition of claim 2, wherein the surfactant is selected from the group consisting of:
anionic surfactants selected from carboxylates, sulphonates, petroleum sulphonates, alkylbenzene sulphonates, naphthalene sulphonates, olefin sulphonates, alkyl sulphates, sulphates, sulphated natural oils and fats, sulphated esters, sulphated alkanolamides, alkylphenols, trisodium citrate dihydrate, sodium acetate, sodium propionate, sodium lactate, sodium glycolate, sodium glycinate, sodium formate, sodium sulfate, and sodium butyrate;
cationic surfactants selected from quaternary ammonium salts, amines with amide linkages, polyoxyethylene alkyl and alicyclic amines, N,N,N,N-tetrakis substituted ethylene diamines, and 2-alkyl-1-hydroxyethyl-2-imidazolines, benzalkonium chloride, benzethonium chloride, Bronidox® (5-bromo-5-nitro-1,3-dioxane), cetrimonium bromide, cetrimonium chloride, dimethyldioctadecylammonium chloride, lauryl methyl gluceth-10 hydroxypropyl dimonium chloride and tetramethylammonium hydroxide, non-ionic (ethoxylated aliphatic alcohol, polyoxyethylene surfactants, carboxylic esters, polyethylene glycol esters, anhydrosorbitol ester and its ethoxylated derivatives, glycol esters of fatty acids, carboxylic amides, monoalkanolamine condensates, polyoxyethylene fatty acid amides, preferably trimethylglycine (betaine), Polyethylene Glycol 600, Polyethylene Glycol 200, Glycerol Sorbitol, Urea Propylene Glycol, ethylene glycol and amino acids such as Proline, Lysine, Serine, Taurine and Glycine; and
zwitterionic surfactants selected from N-coco-3-aminopropionic acid/sodium salt, N-tallow 3-imminodipropionatedisodium salt, N-carboxymethyl-N-dimethyl-N-9-octadecenyl ammonium hydroxide, and N-cocoamidethyl-N-hydroxyethylglycine/sodium salt.

13. The draw solution composition of claim 2 comprising glycerol and trehalose.

14. A method for processing a liquid solvent via forward osmosis, comprising use of a draw solution composition consisting essentially of a water-soluble surfactant.

15. The method of claim 14, further comprising use of a draw solution composition wherein the surfactant is a low molecular weight surfactant.

16. The method of claim 15, further comprising use of a draw solution composition further comprising one or more of the following: water, an additional water-soluble surfactant, and a non-surfactant osmolyte.

17. The method of claim 16, further comprising use of a draw solution composition comprising glycerol and trehalose.

18. The method of claim 15, further comprising regenerating the draw solution composition after use, via at least one process selected from the group consisting of thermal, membrane and aerosol processes.

19. The method of claim 16, further comprising regenerating the draw solution composition after use, via at least one process selected from the group consisting of thermal, membrane and aerosol processes.

20. The method of claim 17, further comprising regenerating the draw solution composition after use, via at least one process selected from the group consisting of thermal, membrane and aerosol processes.

21. A forward osmosis system comprising a first receptacle for a feed stream of liquid to be treated, a second receptacle for a draw solution composition, a membrane situated between the first and second receptacles, and a further apparatus for regenerating the draw solution composition, wherein the draw solution composition consists essentially of a water-soluble surfactant, and wherein the apparatus for regenerating the draw solution composition is selected from the group consisting of forward osmosis (FO) apparatus, forward osmosis membrane bioreactor (FO-MBR) apparatus, PRO (pressure retarded osmosis) apparatus, forward osmosis-reverse osmosis (FO-RO) apparatus, ultrafiltration forward osmosis (UF-FO) apparatus, microfiltration forward osmosis (MF-FO) apparatus, and nanofiltration reverse osmosis (NF-RO) apparatus.

22. The forward osmosis system of claim 21, wherein the draw solution composition further comprises one or more of the following: water, an additional water-soluble surfactant, and a non-surfactant osmolyte.
